(19) United States
(12) Patent Application Publication
(10) Pub. No.: US 2006/0171602 A1
(43) Pub. Date: Aug. 3, 2006

(54) Method and system for using a look-up table for a linear operation in image processing

(75) Inventors: Larry M. Ernst, Longmont, CO (US); Hong Li, Superior, CO (US); Yue Qiao, Longmont, CO (US); Mikel John Stanich, Longmont, CO (US); Chai Wah Wu, Poughquag, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/045,372

(22) Filed: Jan. 31, 2005

(51) Int. Cl. G06K 9/36; G06K 9/40; G06K 9/64

(52) U.S. Cl. 382/248; 382/264; 382/266; 382/279

(57) ABSTRACT

A method and system obtains a linear combination in accordance with an image processing algorithm using at least one lookup table that is indexed by at least one subset of bits from a set of pixels in an image.

### BACKGROUND OF THE INVENTION

1. Field of the Invention

The present invention generally relates to image processing. In particular, the present invention relates to image processing systems and methods that are designed based upon an operation having a linear combination in accordance with an image processing algorithm obtained using a lookup table that corresponds to a subset of bits from a set of pixels.

2. Description of the Related Art

Conventional Look-Up Table (LUT)-based image processing methods and systems perform many multiplication operations by means of lookup tables and then add together the product of each of these multiplication operations. However, these conventional methods and systems have several drawbacks.

First, in these conventional methods and systems, the number of additions that must be performed must equal the number of multiplication operations. Thus, these conventional methods and systems are relatively slow in performance when there are a large number of multiplications.

Second, in these conventional methods and systems, the size of the lookup tables that are used to implement these methods and systems are fixed by the number of bits in each pixel value.

The conventional methods are also less flexible regarding the size of the lookup table and have a limited capability for optimization for specific hardware designs. The conventional methods are less flexible because they employ a fixed structure using a single lookup table. The conventional methods use multiplications having operands with the same number of bits. In summary, these conventional methods and systems are less flexible and slower performing when there are a large number of multiplications.

### SUMMARY OF THE INVENTION

In view of the foregoing and other exemplary problems, drawbacks, and disadvantages of the conventional methods and structures, an exemplary feature of the present invention is to provide a method and system in which a linear combination in accordance with an image processing algorithm is obtained using a lookup table that is indexed by a subset of bits from a set of pixels.

In a first exemplary aspect of the present invention, a method of processing an image defined by a set of pixels, each including a set of bits, includes partitioning the set of bits for a plurality of the pixels into a subset of bits, obtaining an output from at least one lookup table, and summing the output from the at least one lookup table. The lookup table is indexed by a subset of bits from a set of pixels.

In a second exemplary aspect of the present invention, a system for processing an image defined by a set of pixels, each including a set of bits, includes means for partitioning the set of bits for a plurality of the pixels into a subset of bits, means for obtaining an output from at least one lookup table, and means for summing the output from at least one lookup table. The lookup table is indexed by a subset of bits from a set of pixels.

In a third exemplary aspect of the present invention, a method for deploying computing infrastructure, includes integrating computer-readable code into a computing system. The computer-readable code includes instructions for partitioning a set of bits for a plurality of the pixels into a subset of bits, instructions for obtaining an output from at least one lookup table, and instructions for summing the output from the at least one lookup table. The lookup table is indexed by a subset of bits from a set of pixels.

In a fourth exemplary aspect of the present invention, a system for processing an image includes a first processor that partitions a set of bits for a plurality of the pixels into a subset of bits, a second processor that obtains an output from at least one lookup table, and a third processor that sums the output from the at least one lookup table. The lookup table is indexed by a subset of bits from a set of pixels.

Conventional lookup table based-methods and systems for image processing are based upon an analysis at the pixel level. In particular, the conventional methods and systems are designed based upon the relationship between pixels in an image that is being processed.

In stark contrast to the conventional methods and systems for lookup table-based image processing, an exemplary embodiment of the present invention processes an image at the bit level. In other words, the inventors realized that the conventional methods and systems were arbitrarily constrained to an analysis at the pixel level. The inventors have discovered that significant advantages may be obtained when the methods and systems are based upon a selection at the bit level rather than at the pixel level.

An exemplary embodiment of the present invention provides for fast implementation of image processing by using lookup tables for linear combination operations.

Another exemplary embodiment of the present invention provides a greater flexibility when choosing the size of a lookup table that may be used for speeding up linear combination operations in image processing. For example, an exemplary embodiment of the present invention provides for a lookup table having a size that may only be limited by the amount of storage space available on hardware that incorporates the present invention. Further, this feature of an exemplary embodiment of the present invention offers an increase in processing speed in comparison to conventional methods and systems.

Yet another exemplary embodiment of the present invention provides the ability to vary the number of bits used by each pixel, which are used to index the lookup tables, to provide the required multiplication products.

An exemplary embodiment of the present invention relies upon lookup tables to determine linear combinations of subsets of bits of pixel values. This exemplary embodiment of the present invention takes advantage of the computation using all of the bits of a group of pixel values being linear to obtain the necessary result by adding the results of several lookup tables.

Another exemplary embodiment of the present invention provides significant flexibility in determining the size of lookup tables that may be used to perform the linear computations for image processing. In this exemplary embodiment, the size of a lookup table may be determined based upon the number of bits in each pixel value, or by a subset of bits within each pixel value, rather, than being limited to a lookup table having a size that is dictated by the total number of bits in each pixel value, as has been conventionally limiting to lookup table based image processing.

Further, this exemplary embodiment of the present invention enables the size of the lookup table to be optimized based upon the specifications of the hardware that will incorporate the image processing system of the present invention. This is in stark contrast to the conventional lookup table-based image processing methods and systems, which dictate the size of the lookup table based upon the total number of bits for each pixel value. In other words, the present invention enables optimization of the size of the lookup tables that are used to perform the linear combination operations by determining the structure of these lookup tables based upon a selection at the bit level of the linear combination, rather than based upon a selection at the pixel level as has conventionally been done.

These and many other advantages may be achieved with the present invention.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a set of bits in accordance with an exemplary embodiment of the present invention;

FIG. 2 illustrates a set of bits of FIG. 1 partitioned in accordance with an exemplary embodiment of the present invention;

FIG. 3 illustrates yet another set of bits where the number of bits from some of the pixels are larger than the number of bits from some of the other pixels in accordance with yet another exemplary embodiment of the present invention;

FIG. 4 is a flowchart that illustrates a control routine in accordance with an exemplary embodiment of the present invention;

FIG. 5 illustrates an exemplary image processing system 500 in accordance with an exemplary embodiment of the present invention;

FIG. 6 illustrates a signal bearing medium 600 storing the instructions for a program in accordance with an exemplary embodiment of the present invention; and

FIG. 7 illustrates a processor 700 in accordance with yet a further exemplary embodiment of the present invention.

### DETAILED DESCRIPTION OF EXEMPLARY EMBODIMENTS OF THE INVENTION

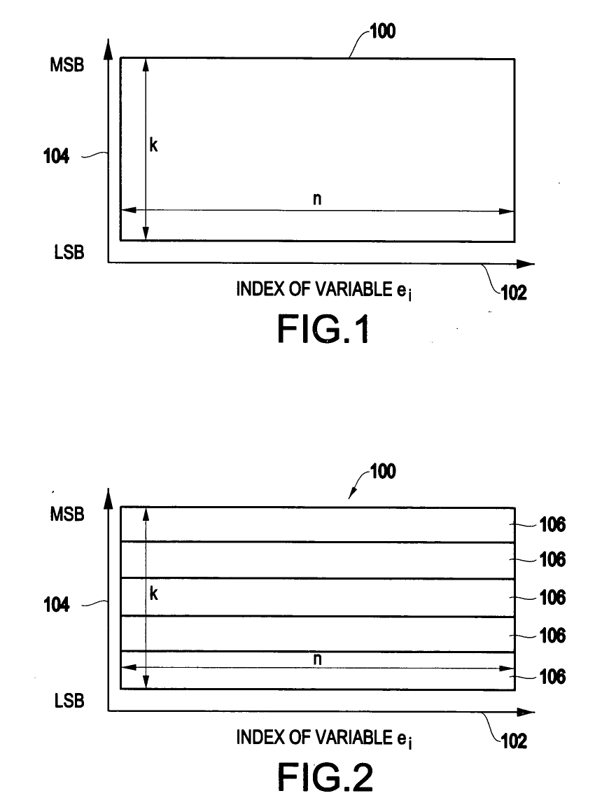

Referring now to the drawings, and more particularly to FIGS. 1-7, there are shown exemplary embodiments of the methods and structures of the present invention.

An exemplary embodiment of the present invention replaces intensive computations in image processing algorithms, such as linear combinations of bits with lookup tables. For the purpose of the present application, a “linear combination of bits” means any combination of bits for which an output is directly proportional to the input. For instance, a conventional error diffusion image processor may rely upon both a quantizer and a subtraction operation to compute an error for a single pixel possibly implemented as a one-dimensional lookup table. The most intensive computation is the calculation of the modified input which requires a linear combination of errors, as is explained below.

The operation of error diffusion basically spreads the error occurring at a given pixel across neighboring pixels. The spreading of the error is described by an ordered set of numbers called “filter coefficients” forming together an error filter. At each point, the input image data is combined with the diffused error forming a modified input, and the output pixel is determined by comparing the modified input to a threshold value.

A first conventional method and system of implementing error diffusion computes the error at a current pixel as the difference between the modified input and the output pixel. This error is then multiplied by several filter coefficients or weighting factors, and is then spread across neighboring pixel values. This conventional multiplication of an error value with multiple weights is replaced with a lookup table in the invention.

This first method and system provides a lookup table with 2^{k}nk bits of storage space and is indexed with k bits, where k is the number of bits for each pixel value and n is the number of weights in the filter kernel for the corresponding error diffusion process.

Further, in this first conventional method and system, n additions are needed to add the n different k-bit outputs to the n pixels.

In a second conventional method and system, error diffusion is performed by taking the errors from the pixels in the neighborhood of a current pixel, multiplying those errors by weighting factors and then adding them to the current pixel value to calculate the modified input. This process involves a linear combination of the error values from several pixels (i.e. the neighboring pixels).

In an exemplary embodiment of the present invention, the second conventional method and system for determining error diffusion is modified by replacing the linear combination of the error values with at least one lookup table.

In this exemplary embodiment of the present invention, each lookup table calculates the linear combination of a subset of bits from the pixels that are in the neighborhood of the current pixel.

Preferably, the bits that are covered by each lookup table do not overlap to maintain the linearity of the relationship between the input and output of the combination.

Preferably, all of the lookup tables together cover all of the bits in the entire neighborhood of pixels.

The modified input for the current pixel value x in accordance with an error diffusion algorithm is set forth by the following equation:
Modified Input=a1*e1+a2*e2+ . . . +an*en+x;

where:

ei is an error value from a neighboring pixel;

n is the number of pixels in the neighborhood of the current pixel x; and

ai is a weight assigned by the corresponding error diffusion kernel (or error diffusion filter) to a pixel xi.

The lookup table is used to compute the linear combination a1*e1+a2*e2+ . . . +an*en. Each of the error values ei includes k bits. Thus, the total number of bits for all of error values of the pixels in the neighborhood (i.e., error value e1 to error value en) is kn.

FIG. 1 illustrates the total number of bits 100 in accordance with this exemplary embodiment where the horizontal axis 102 is indexed based upon a corresponding neighboring error value ei where i varies from 1 to n and the vertical axis 104 is indexed based upon the significance of each bit within each of the neighboring error values (e1 to en), which each have k bits.

The total number of bits 100 that is illustrated by FIG. 1 may be partitioned into h subsets of bits 106. Each of the h subsets of bits may have a corresponding lookup table. The h lookup tables may then be used to compute the linear combination simply by adding the output from each of the lookup tables. In other words, each lookup table computes the linear combination of a subset of bits from the total number of bits.

In one sense, the conventional look-up-table methods and systems also divide the totality of bits into subsets of bits. However, these conventional methods and systems always divide the total number of bits into subsets of bits that correspond to individual pixels. In stark contrast, an exemplary embodiment of the present invention divides the total number of bits into subsets of bits that extend across a plurality of pixels.

The partitioning of the total number of bits 100 of FIG. 1 into h subsets of bits 106 in accordance with an exemplary embodiment of the present invention is illustrated by the horizontal lines of FIG. 2. Each horizontal line divides the total number of bits 100 into a subset of bits 106, corresponding to bit planes, to provide h subsets of bits 106 from a plurality of pixels.

Further, by choosing the partition appropriately, the number of lookup tables may be reduced. For example, in an exemplary embodiment of the present invention, if the number h of lookup tables equals the number k of bits in each pixel and as partitioned in FIG. 2, then each lookup table differs from an adjacent lookup table only in that the bits in each table are shifted by one bit. In this instance, the number of lookup tables may be reduced from h lookup tables to a single lookup table where the output of the lookup table is shifted by the number of bits depending on which subset of pixels in FIG. 2 is used to index the lookup table.

In this exemplary embodiment, each lookup table computes the linear combination of a single bit of errors across all of the pixels in a neighborhood of a current pixel.

This exemplary embodiment computes the linear combination of the m-th bit of each error in the neighborhood using a single lookup table by bit-shifting the output of the lookup table m times. In this instance, a single lookup table is sufficient. Thus, a reduced number of lookup tables may be required where each lookup table provides a linear combination of errors for adjacent bits of errors for each pixel in the neighborhood.

Similarly, only one lookup table is needed if the first lookup table computes the linear combination of the first r bits of each pixel and the second lookup table computes the next r bits of each pixel, etc. Other partitions of bits which also have this property include, for example, when the first lookup table computes the linear combination of the 1^{st}, 3^{rd}, 5^{th}, etc, bits of all the pixels and the second lookup table computes the 2^{nd}, 4^{th}, 6^{th}, etc. bits of all the pixels. In yet another exemplary embodiment of the present invention, the number of bits in the pixel plane that are used may be varied based upon the coefficients in the error filter. For example, the number of bits from the pixels that are multiplied by the larger coefficients in the filter may be larger than the number of bits from the pixels that have smaller coefficients.

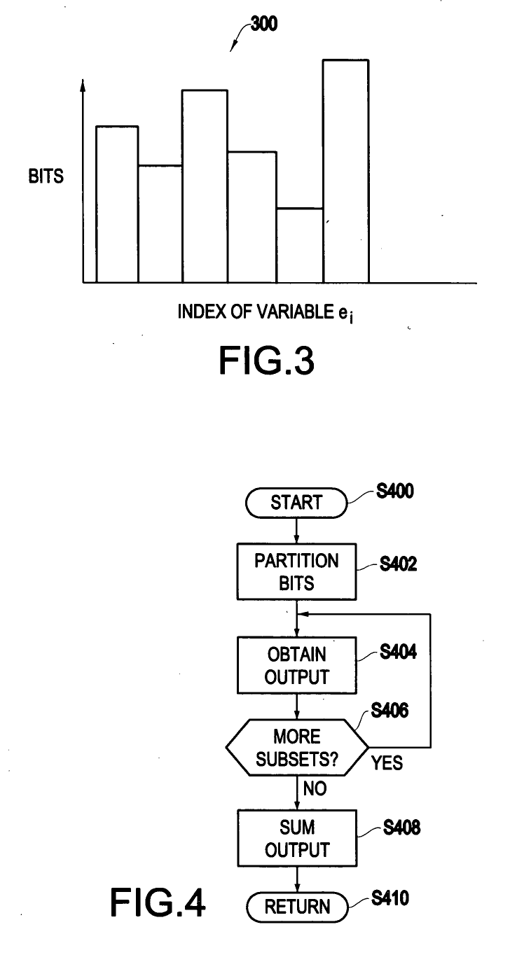

This exemplary embodiment is illustrated by the bit plane 300 of FIG. 3, which shows that the number of bits from some of the pixels is larger than the number of bits from some of the other pixels.

This exemplary embodiment of the present invention provides an additional layer of flexibility in image processing that may result in significantly faster implementations while still requiring less memory. This additional layer of flexibility is based upon the inventors discovery that the image processing based upon linear combinations can be optimized based upon a selection of the total number of bits, rather, than merely upon a selection of the pixel values. These advantages are not available with the conventional look-up-table based methods and systems because as explained above, the conventional methods and systems are limited to an analysis at the pixel level.

In yet another exemplary embodiment of the present invention that is described by the following description, the error values are scaled and a constant is added in order to fit them into k bits, i.e., the scaled values (after adding the constant) are stored in the lookup table. This does not incur many extra computations since the quantization in error diffusion can be done on the scaled values, i.e. there is no need to undo the scaling before performing the quantization operation.

The Jarvis error diffusion algorithm uses the following error filter

(filter kernel):

| | | | | |
|---|---|---|---|---|
| 0 | 0 | X | 7/48 | 5/48 |
| 3/48 | 5/48 | 7/48 | 5/48 | 3/48 |
| 1/48 | 3/48 | 5/48 | 3/48 | 1/48 |

For purposes of illustration, assume that eight (8) bits are used to store the error for each of the pixels. The conventional lookup table-based Jarvis error diffusion algorithm requires the use of one lookup table and the addition of twelve (12) numbers per process pixel to provide the desired linear combination. In other words, the number of lookup table accesses and additions conventionally must equal the number of coefficients that are present in the Jarvis error diffusion error filter.

In stark contrast, with an exemplary embodiment of the present invention, the number of lookup tables and the number of addition operations may be reduced. For example, since the error for each pixel may be represented using eight (8) bits, the total number of bits may be divided in such a manner that eight (8) lookup tables may be used and the output from each of these lookup tables may be added to the input pixel value to provide the desired linear combination output, which is equal to the Modified Input value. In this exemplary embodiment, the number of additions is reduced to the number of bits for each error value.

Thus, in accordance with an exemplary embodiment of the present invention, the lookup table may be chosen such that the size of the lookup table, the number of lookups in the table and the number of additions may be adjusted. This ability to adjust provides a flexibility that is currently absent in the conventional methods and systems.

In yet another exemplary embodiment of the present invention, a lookup table is provided that computes the addition of a linear combination of error values and the current pixel value to provide the modified input value. In other words, the modified input value may be determined based upon the following relationship:
Modified Input=a1*e1+a2*e2+ . . . +an*en+I

Where:

ai is the error diffusion kernel coefficient;

ei is the error value; and

I is the current pixel value.

While the lookup table in the previous embodiment computes the linear combination of error values, the lookup table in this embodiment computes a linear combination of errors plus the current pixel value, i.e. the lookup table computes directly the Modified Input. Some error diffusion kernels include coefficients that are powers of two (before scaling) in order to speed up computation, albeit with a possible loss of output quality. The filter kernels for the Shiau-Fan and Stucki algorithms are illustrated below:

For Shiau-Fan:

| | | | | |
|---|---|---|---|---|
| 0 | 0 | 0 | X | 8/16 |
| 1/16 | 1/16 | 2/16 | 4/16 | 0 |

For Stucki:

| | | | | |
|---|---|---|---|---|
| 0 | 0 | X | 8/42 | 4/42 |
| 2/42 | 4/42 | 8/42 | 4/42 | 2/42 |
| 1/42 | 2/42 | 4/42 | 2/42 | 1/42 |

These filter kernels have five (5) and twelve (12) coefficients, respectively.

In an exemplary embodiment of the present invention that may rely upon either of these filter kernels, the speed of computation may not be affected by the value of the coefficients.

Indeed, the flexibility of an exemplary embodiment of the present invention may allow the weights to be optimized to provide a better output. See for instance, Kolpatzik and Bouman, “Optimized error diffusion for image display,” Journal of Electronic Imaging, vol. 1, no. 3, page 277-292, 1992 for a method to optimize error diffusion weights, which is incorporated herein by reference in its entirety.

In an exemplary embodiment of the present invention, where the number of bits is different for each weight, the Shiau-Fan error diffusion may be implemented using a lookup table with the following bit distribution:

| | | | | |
|---|---|---|---|---|
| 0 | 0 | 0 | X | 8 |
| 4 | 4 | 6 | 8 | 0 |

In other words, for the pixels which are multiplied with the weight 1/16, this exemplary embodiment only takes the four most significant bits of these pixels. For the pixels which are multiplied with the weight 2/16, this exemplary embodiment only takes the six most significant bits of these pixels.

For the pixels that are multiplied with the weights 4/16 and 8/16, this exemplary embodiment only takes the eight most significant bits. Then, two lookup tables are used to implement the linear combination. Each lookup table is indexed by half of the bits allocated to each pixel, and, thus, each lookup table is indexed by 2+2+3+4+4=15 bits. As explained above, in an exemplary embodiment of the present invention, these two lookup tables are identical except for a shift of bits at the output and, thus, only one lookup table suffices.

While the above-described exemplary embodiments of the present invention are described with reference to particular algorithms, such as an error diffusion algorithm, any algorithm which includes a computation of a linear combination of a collection of pixels values may be improved by the present invention. Examples of such algorithms include, for example, a discrete cosine transform, an error diffusion algorithm, an image convolution algorithm, an image edge enhancement algorithm, an image blurring algorithm, a discrete wavelet transform, a Direct Binary Search halftoning algorithm and the like.

Additionally, exemplary embodiments of the present invention may be used for implementing the successive approximation mode of a progressive standard from the Joint Photographic Experts Group (JPEG), which computes a linear combination of subsets of bits from pixel values at each phase.

Further, an exemplary embodiment of the present invention may also speed up error diffusion algorithms which use multiple filters, such as those described in U.S. Pat. No. 6,006,011, which is incorporated herein in its entirety.

An exemplary embodiment of a subroutine for computing a linear combination of pixel values for the present invention is illustrated by the flowchart of FIG. 4. The subroutine starts at step S400 and continues to step S402. In step S402, the subroutine partitions the bits of errors across a plurality of pixels into a subset of bits and continues to step S404.

In step S404, the subroutine obtains an output from at least one lookup table indexed by a subset of bits and continues to step S406. As explained above, the at least one lookup table is indexed by the subset of bits. In step S406, the subroutine determines if there are more subsets of bits in the partition. If, in step S406, the subroutine determines that there are more subsets in the partition, then the subroutine returns to step S404. If, however, in step S406, the subroutine determines that there are no more subsets in the partition, then the control routine continues to step S408.

In step S408, the subroutine sums the output from the at least one lookup table and continues to step S410. In step S410, the subroutine returns to the process that initiated the subroutine of FIG. 4.

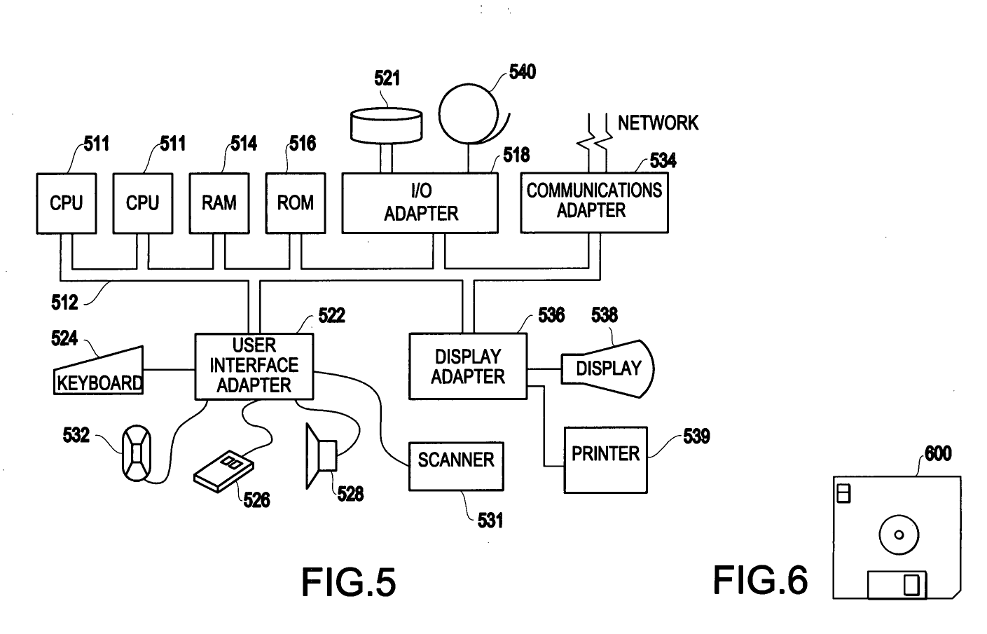

FIG. 5 illustrates a typical hardware configuration of an image processing system incorporating an exemplary embodiment of the present invention and which preferably has at least one processor or central processing unit (CPU) 511.

The CPUs 511 are interconnected via a system bus 512 to a random access memory (RAM) 514, a read-only memory (ROM) 516, an input/output (I/O) adapter 518 (for connecting peripheral devices such as disk units 521 and tape drives 540 to the bus 512), a user interface adapter 522 (for connecting a keyboard 524, mouse 526, speaker 528, scanner 531, microphone 532, and/or other user interface device to the bus 512), a communication adapter 534 for connecting an information handling system to a data processing network, the Internet, an Intranet, a personal area network (PAN), etc., and a display adapter 536 for connecting the bus 512 to a display device 538 and/or printer 539.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 511, as represented by the fast-access storage, for example. Alternatively, the instructions may be contained in another signal-bearing media, such as a magnetic data storage diskette 600 (FIG. 6), directly or indirectly accessible by the CPU 511.

Whether contained in the diskette 600, the computer/CPU 511, or elsewhere, the instructions may be stored on a variety of machine-readable data storage media, such as a DASD storage (e.g., a conventional “hard drive” or a RAID array), a magnetic tape, an electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

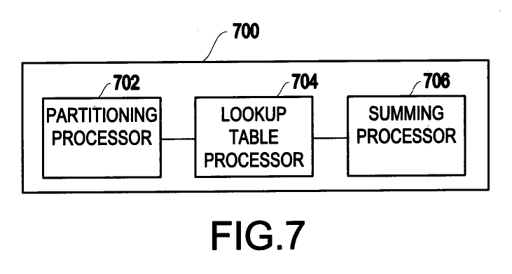

FIG. 7 illustrates an exemplary processor 700 in accordance with an exemplary embodiment of the present invention. The processor 700 includes a partitioning processor 702, a lookup table processor 704, and a summing processor 706. The partitioning processor 702 partitions the bits for a plurality of pixels from an image into a subset of bits. The lookup table processor 704 obtains an output from at least one lookup table. The summing processor 706 sums the output from the at least one lookup table.

For the purpose of the this description, a lookup table is intended to include, without limitation, any memory structure that may be accessed or indexed by an address. Examples of lookup tables may include computer memory arrays, hash tables and any collection of data whose individual datum may be retrieved or changed by supplying an index, an address, or the like.

While the invention has been described in terms of several exemplary embodiments, those skilled in the art will recognize that the invention can be practiced with modification.

Further, it is noted that, Applicants' intent is to encompass equivalents of all claim elements, even if amended later during prosecution.

What is claimed is:

1. A method for processing an image defined by at least one pixel, each pixel comprising a set of bits, the method comprising:
partitioning said set of bits for a plurality of said pixels into at least one subset of bits;
obtaining an output from at least one lookup table, wherein said lookup table is indexed by said subset of bits; and
summing the output from said at least one lookup table.

2. The method of claim 1, wherein said set of bits comprises an error for processing each of said plurality of pixels.

3. The method of claim 1, wherein said at least one lookup table computes a linear combination of said subset of bits.

4. The method of claim 1, wherein said at least one lookup table is based upon an error diffusion filter.

5. The method of claim 1, wherein said at least one lookup table is based upon one of a discrete cosine transform, an image convolution, an image edge enhancement algorithm, an image blurring algorithm, and a discrete wavelet transform.

6. The method of claim 1, wherein said at least one lookup table is based upon a successive approximation mode of a progressive standard from the Joint Photographic Experts Group (JPEG).

7. The method of claim 1, wherein the size of said at least one lookup table is based upon an amount of storage space in a memory.

8. The method of claim 1, wherein said at least one lookup table comprises a plurality of lookup tables.

9. The method of claim 8, wherein each of said plurality of lookup tables determines the linear combination of the m-th bit across said plurality of pixels in the neighborhood of a current pixel.

10. The method of claim 8, wherein one of said plurality of lookup tables is smaller than another one of said plurality of lookup tables.

11. The method of claim 10, wherein the number of bits indexing said one of said plurality of lookup tables is less than the number of bits indexing said another one of said plurality of lookup tables.

12. The method of claim 8, wherein the number of bits indexing one of said plurality of lookup tables is based upon coefficients in a filter kernel.

13. The method of claim 8, wherein the number of bits indexing one of said plurality of lookup tables is proportional to the coefficients in a filter kernel.

14. The method of claim 8, wherein the number of said plurality of lookup tables is based upon the number of bits in each of said pixels.

15. The method of claim 8, wherein the plurality of lookup tables are other than overlapping.

16. The method of claim 8, wherein the plurality of lookup tables cover all of said subsets of bits of a plurality of said pixels.

17. A system for processing an image defined by at least one pixel, each pixel comprising a set of bits, the system comprising:
means for partitioning said set of bits for a plurality of said pixels into at least one subset of bits;
means for obtaining an output from at least one lookup table, wherein said lookup table is indexed by said subsets of bits; and
means for summing the output from said at least one lookup table.

18. A method for deploying computing infrastructure, comprising integrating computer-readable code into a computing system, the computer-readable code comprising:
instructions for partitioning a set of bits for at least one of a plurality of pixels of an image into at least one subset of bits;
instructions for obtaining an output from at least one lookup table, wherein said lookup table is indexed by said subsets of bits; and
instructions for summing the output from said at least one lookup table.

19. A system for processing an image, comprising:
a first processor that partitions a set of bits for at least one of a plurality of pixels of said image into at least one subset of bits;
a second processor that obtains an output from at least one lookup table, wherein said lookup table is indexed by said subsets of bits; and
a third processor that sums the output from said at least one lookup table.

20. The system of claim 19, wherein said first, second, and third processor form a single processor.
